(19) United States
(12) Patent Application Publication
(10) Pub. No.: US 2023/0099818 A1
(43) Pub. Date: Mar. 30, 2023

(54) SPRAY NOZZLE, NOZZLE TIP PART, AND THERMAL SPRAYING DEVICE

(71) Applicant: TATSUTA ELECTRIC WIRE & CABLE CO., LTD., Osaka (JP)

(72) Inventor: Masaki HIRANO, Kyoto (JP)

(21) Appl. No.: 17/908,116

(22) PCT Filed: Mar. 5, 2021
(86) PCT No.: PCT/JP2021/008628

§ 371 Date: Aug. 30, 2022

(30) Foreign Application Priority Data
Mar. 5, 2020 (JP) 2020-037976

(51) Int. Cl. C23C 24/04

(52) U.S. Cl. CPC C23C 24/04

(57) ABSTRACT

Provided is a spray nozzle that makes it possible to reduce a difference in film thickness in a film. A spray nozzle (1) for use in a cold spray device (100) includes: a nozzle main body (15) that has a first path (20) through which a film material and a carrier gas pass; and a nozzle tip section (16) that is provided at a tip section of the nozzle main body (15) and has a second path (21) which communicates with the first path (20), the second path (21) being broadened at a position apart from a cross-sectional center (P) of the second path (21).

### TECHNICAL FIELD

The present invention relates to a spray nozzle for use in a thermal spray device, a nozzle tip section, and a thermal spray device provided with the spray nozzle.

### BACKGROUND ART

As a conventional thermal spraying technique, for example, cold spraying is known. Typically, a spray nozzle used in cold spraying has a Laval nozzle structure capable of accelerating a high-pressure gas from a subsonic speed to a supersonic speed. Moreover, the spray nozzle has a circular cross section or a rectangular cross section. Such a conventional spray nozzle is disclosed, for example, in Patent Literature 1.

### CITATION LIST

### Patent Literature

[Patent Literature 1]

Published Japanese Translation of PCT International Application Tokuhyo No. 2008-540115 (Publication Date: Nov. 20, 2008)

### SUMMARY OF INVENTION

### Technical Problem

The conventional technique as described above has the following problems.

In a case where a high-pressure gas (fluid) passes through a conventional spray nozzle used in cold spraying, the fluid is accelerated by the Laval nozzle structure, and fluid energy is increased. The fluid energy is highest at a center of a cross section of the spray nozzle, and becomes lower as the fluid approaches a wall surface. As a result, a film on an object (e.g., a substrate) is thicker at the center, and becomes thinner toward edge portions. Alternatively, if the fluid energy is excessively high at the center of the cross section of the spray nozzle, the center of the film may collapse.

As described above, with the conventional spray nozzle, the film thickness of the film tends to be unstable. In a case where the film thickness of the film is unstable, there arises a problem that film characteristics (such as electrical characteristics, adhesiveness, or hardness) also become unstable. Other thermal spraying techniques (such as aerosol deposition) using a spray nozzle have similar problems.

The present invention is accomplished in view of the above problems, and an object of the present invention is to provide a spray nozzle, a nozzle tip section, and a thermal spray device each of which is capable of reducing a difference in film thickness in a film.

### Solution to Problem

In order to attain the object, a spray nozzle in accordance with an aspect of the present disclosure is a spray nozzle for use in a thermal spray device, the spray nozzle including: a nozzle main body that has a first path through which a film material and a carrier gas pass; and a nozzle tip section that is provided at a tip section of the nozzle main body and has a second path which communicates with the first path, the second path being broadened at a position apart from a cross-sectional center of the second path.

In order to attain the object, a nozzle tip section in accordance with an aspect of the present disclosure is a nozzle tip section which is provided in a spray nozzle of a thermal spray device, in which: the nozzle tip section is provided at a tip section of a nozzle main body that has a first path through which a film material and a carrier gas pass; and the nozzle tip section has a second path which communicates with the first path, the second path being broadened at a position apart from a cross-sectional center of the second path.

### Advantageous Effects of Invention

According to an aspect of the present disclosure, it is possible to reduce a difference in film thickness in a film.

### BRIEF DESCRIPTION OF DRAWINGS

FIG. 1 schematically illustrates a shape of a spray nozzle in accordance with an embodiment of the present invention, where the left part illustrates a side view of the spray nozzle, and the right part illustrates a tip section of the spray nozzle.

FIG. 2 is a view schematically illustrating a cold spray device in accordance with an embodiment of the present invention.

FIG. 3 illustrates other examples of a second path in accordance with an embodiment of the present invention.

FIG. 4 is a photograph showing an example of a tip section of a spray nozzle in accordance with an Example of the present invention.

FIG. 5 is a graph comparing a film thickness of a film obtained by the spray nozzle in accordance with the embodiment illustrated in FIG. 4 with that by a conventional spray nozzle.

### DESCRIPTION OF EMBODIMENTS

Embodiments are described below with reference to the drawings. In the following description, identical components and identical constituent elements are given respective identical reference signs. Such components and constituent elements are also identical in name and function. Thus, a specific description of those components and constituent elements is not repeated.

The present embodiment is applicable to thermal spray devices (methods) in general. Examples of the thermal spray device (method) include cold spraying, aerosol deposition, and the like. In the present embodiment, cold spraying will be described as an example.

[Cold Spraying]

In recent years, a film forming method, that is called “cold spraying,” has been used. The cold spraying is a method for (i) causing a carrier gas, whose temperature is lower than a melting point or a softening temperature of a film material, to flow at a high speed, (ii) introducing the film material into the flow of the carrier gas and increasing the speed of the carrier gas into which the film material has been introduced, and (iii) causing the film material to collide with, for example, a base material at a high speed while the film material is in a solid phase so as to form a film.

A principle of film formation by use of the cold spraying is understood as below.

A collision speed of not less than a certain critical value is required for a film material to adhere to and accumulate on a base material so as to form a film on the film material. Such a collision speed is hereinafter referred to as a critical speed. In a case where the film material collides with the base material at a speed that is lower than the critical speed, the base material is worn, so that small crater-shaped cavities are merely formed in the base material. The critical speed is changed in accordance with, for example, a material, a size, a shape, a temperature, and/or an oxygen content of the film material, or a material of the base material.

In a case where the film material collides with the base material at a speed that is not less than the critical speed, plastic deformation caused by a great shearing force occurs near an interface between the film material and the base material (or the film which has already been formed). The plastic deformation and generation of a great shock wave in a solid due to the collision cause an increase in temperature near the interface, and in this process, solid phase bonding occurs (i) between the film material and the base material and (ii) between the film material and the film (or the film material which has already adhered to the base material).

(Cold Spray Device 100)

FIG. 2 is a view schematically illustrating the cold spray device 100. As illustrated in FIG. 2, the cold spray device 100 includes a tank 110, a heater 120, a spray nozzle 1, a feeder 140, a base material holder 150, and a control device (not illustrated).

The tank 110 stores therein a carrier gas. The carrier gas is supplied from the tank 110 to the heater 120. Examples of the carrier gas include nitrogen, helium, air, and a mixed gas of nitrogen, helium, and air. A pressure of the carrier gas is adjusted so that the pressure of the carrier gas at the exit of the tank 110 is, for example, not less than 70 PSI and not more than 150 PSI (not less than approximately 0.48 Mpa and not more than approximately 1.03 Mpa). Note, however, that the pressure of the carrier gas at the exit of the tank 110 does not necessarily need to fall within the above range, and such pressure is appropriately adjusted in accordance with, for example, material(s) and/or a size of a film material, or material(s) of a base material.

The heater 120 heats the carrier gas which has been supplied from the tank 110. More specifically, the carrier gas is heated to a temperature that is lower than a melting point of the film material which is supplied from the feeder 140 to the spray nozzle 1. For example, the carrier gas is heated so that the temperature of the carrier gas at an exit of the heater 120 falls within the range of not less than 50° C. and not more than 500° C. Note, however, that a heating temperature of the carrier gas at the exit of the heater 120 does not necessarily need to fall within the above range, and is appropriately adjusted in accordance with, for example, the material(s) and/or the size of the film material, or the material(s) of the base material.

The carrier gas is heated by the heater 120 and is then supplied to the spray nozzle 1.

The spray nozzle 1 (i) causes an increase in speed of the carrier gas which has been heated by the heater 120 to a speed in a range of not less than 300 m/s and not more than 1200 m/s and (ii) causes the carrier gas to be sprayed therethrough onto a base material 170. Note, however, that the speed of the carrier gas does not necessarily need to fall within the above range, and is appropriately adjusted in accordance with, for example, the material(s) and/or the size of the film material, or the material(s) of the base material.

The feeder 140 supplies the film material to the flow of the carrier gas whose speed is accelerated by the spray nozzle 1. The film material which is supplied from the feeder 140 has a particle size of, for example, not less than 1 μm and not more than 50 μm. Together with the carrier gas, the film material which has been supplied from the feeder 140 is sprayed through the spray nozzle 1 onto the base material 170.

The base material holder 150 fixes the base material 170. Onto the base material 170 which has been fixed by the base material holder 150, the carrier gas and the film material are sprayed, through the spray nozzle 1. A distance between a surface of the base material 170 and a tip of the spray nozzle 1 is adjusted so that the distance falls within the range of, for example, not less than 1 mm and not more than 30 mm. In a case where the distance between the surface of the base material 170 and the tip of the spray nozzle 1 is less than 1 mm, a spraying speed at which the film material is sprayed is decreased. This is because the carrier gas, sprayed from the spray nozzle 1, flows back into the spray nozzle 1. During the flowing back, a pressure, generated when the carrier gas flows back, can cause a member (e.g., a hose) connected to the spray nozzle 1 to be detached from the spray nozzle 1. Note, however, that in a case where the distance between the surface of the base material 170 and the tip of the spray nozzle 1 is more than 30 mm, efficiency in film formation is decreased. This is because it becomes more difficult for the carrier gas and the film material, which have been sprayed from the spray nozzle 1, to reach the base material 170.

Note, however, that the distance between the surface of the base material 170 and the tip of the spray nozzle 1 does not necessarily need to fall within the above range, and is therefore appropriately adjusted in accordance with, for example, the material(s) and/or the size of the film material, or the material(s) of the base material.

The control device controls the cold spray device 100 in accordance with information stored therein in advance and/or an input by an operator. More specifically, the control device controls, for example, (i) the pressure of the carrier gas which is supplied from the tank 110 to the heater 120, (ii) the temperature of the carrier gas which is heated by the heater 120, (iii) a kind and an amount of the film material which is supplied from the feeder 140, and (iv) the distance between the surface of the base material 170 and the spray nozzle 1.

The cold spray device 100 may use a well-known film material in order to perform the cold spraying. For example, nickel powder, tin powder, or a mixed material of tin powder and zinc powder can be used as a film material.

The use of the cold spray device 100 allows enjoying advantages of cold spraying. The cold spraying brings about, for example, the following advantages: (1) prevention of oxidization of a film, (2) prevention of a change in quality of a film by heat, (3) formation of a dense film, (4) prevention of generation of fumes, (5) minimum masking, (6) film formation achieved by a simple device, and (7) formation of a thick metal film achieved in a short period of time.

(Spray Nozzle)

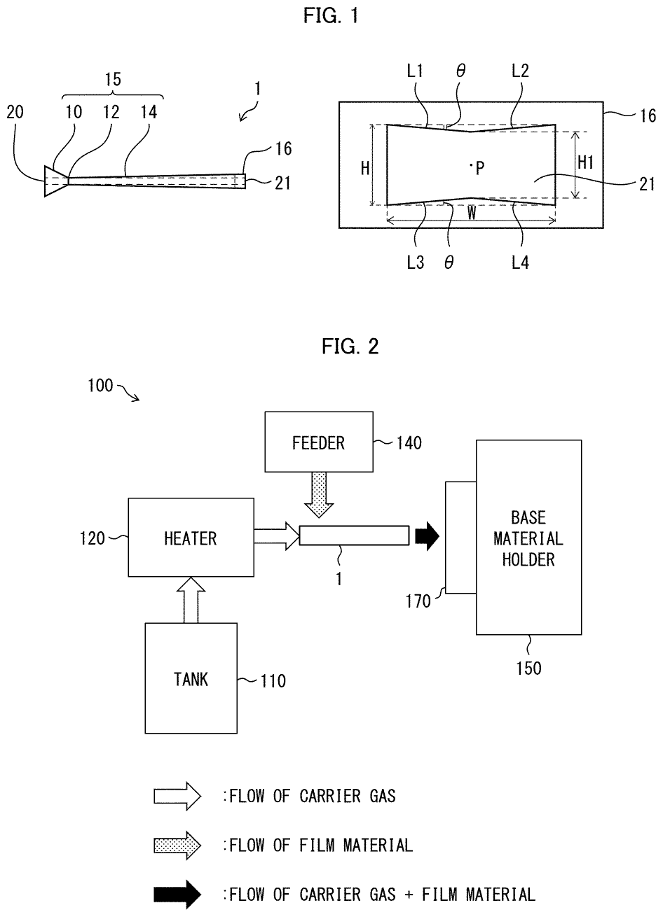

The following description will discuss a spray nozzle 1 in accordance with the present embodiment with reference to FIG. 1 and the like. In the following description, a term “cross section” refers to a cross section of a path (i) which is formed in the spray nozzle 1, (ii) through which the film material and the carrier gas pass, and (ii) which lies in a direction perpendicular to a flow direction of the film material and the carrier gas.

FIG. 1 schematically illustrates a shape of the spray nozzle 1 in accordance with the present embodiment, where the left part illustrates a side view (top view) of the spray nozzle 1, and the right part illustrates a tip section 16 of the spray nozzle 1.

The spray nozzle 1 is, for example, a tapered divergent nozzle. The spray nozzle 1 includes a nozzle main body 15 and a tip section (nozzle tip section) 16. The nozzle main body 15 is constituted, along a flow of the film material and the carrier gas, by a cross-sectional area reduction section 10, a throat section 12, and a cross-sectional area expansion section 14, in this order.

The cross-sectional area reduction section 10 is a portion where a cross-sectional area of the spray nozzle 1 is gradually reduced along the flow of the film material and the carrier gas. The throat section 12 is a portion where the cross-sectional area of the spray nozzle 1 is smallest. The cross-sectional area expansion section 14 is a portion where the cross-sectional area of the spray nozzle 1 is gradually enlarged along the flow of the film material and the carrier gas. The tip section 16 is an exit portion from which the film material and the carrier gas are ejected.

The cross-sectional area reduction section 10, the throat section 12, the cross-sectional area expansion section 14, and the tip section 16 may be integrally formed. Alternatively, the tip section 16 may be configured to be detachable from the cross-sectional area expansion section 14. In a case where the tip section 16 is attached to/taken off from the cross-sectional area expansion section 14, the tip section 16 may be attached to/taken off from the cross-sectional area expansion section 14 in any known manner.

The cross-sectional area reduction section 10, the throat section 12, and the cross-sectional area expansion section 14 have a first path 20 through which the film material and the carrier gas pass. The tip section 16 has a second path 21 that communicates with the first path 20. As illustrated in FIG. 1 (right part), a cross section of the second path 21 has a substantially rectangular shape with a width W and a height H. A point P in FIG. 1 is an intersection of diagonals of the rectangular cross section, and indicates a cross-sectional center of the second path 21. A height of the second path 21 at the point P is H1 (H1<H).

A cross section of the spray nozzle 1 has a rectangular shape. A cross section of the second path 21 has a substantially rectangular shape. Each of sides L1 through L4 corresponding to the longer sides of the cross section of the second path 21 is inclined at an angle of θ with respect to the longer sides of the cross section of the spray nozzle 1. With the configuration, the second path 21 is broadened at a position apart from the cross-sectional center P. Consequently, the second path 21 has, at the position apart from the cross-sectional center P, a height greater than the height H1.

The first path 20 may have a rectangular cross section. It is possible that a cross-sectional shape of the first path 20 and a cross-sectional shape of the second path 21 are similar figures, and the first path 20 has an inner surface which is flush with an inner surface of the second path 21.

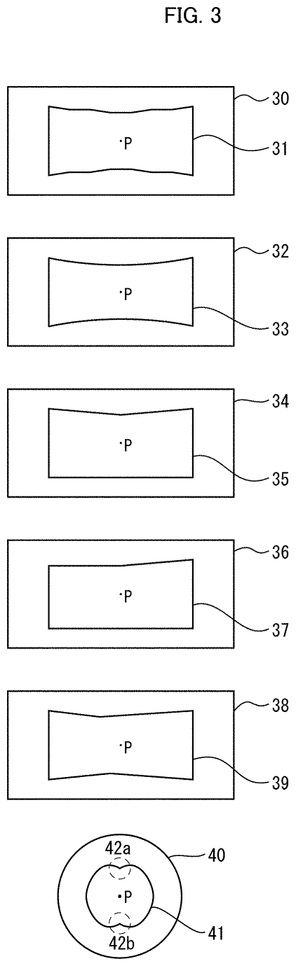

The second path 21 may have a cross-sectional shape that differs from the cross-sectional shape illustrated in FIG. 1, as long as the second path 21 is broadened at the position apart from the cross-sectional center P. Other examples of the second path 21 will be described with reference to FIG. 3.

FIG. 3 illustrates other examples of the second path in accordance with the present embodiment. The following description will discuss the plurality of examples in order from the top. In all the examples, the second path is commonly broadened at a position apart from the cross-sectional center P.

A tip section 30 has a second path 31 having a substantially rectangular shape. In the second path 31, portions corresponding to two longer sides of the rectangle are formed to have stepped shapes.

A tip section 32 has a second path 33 having a substantially rectangular shape. In the second path 33, portions corresponding to two longer sides of the rectangle are formed to have arc shapes.

A tip section 34 has a second path 35 having a substantially rectangular shape. The second path 35 differs from the second path 21 in the following point. Specifically, in the second path 21, the portions corresponding to two longer sides of the rectangle are inclined. Meanwhile, in the second path 35, a portion corresponding to only one longer side of the rectangle is inclined.

A tip section 36 has a second path 37 having a substantially rectangular shape. The second path 37 differs from the second path 35 in the following point. Specifically, in the second path 35, the portion corresponding to one longer side of the rectangle is inclined. Meanwhile, in the second path 37, a portion corresponding to only a half of one longer side of the rectangle is inclined.

A tip section 38 has a second path 39 having a substantially rectangular shape. The second path 39 differs from the second path 21 in the following point. Specifically, the cross section of the second path 21 is point-symmetric with respect to the cross-sectional center P. Meanwhile, a cross section of the second path 39 is not point-symmetric with respect to the cross-sectional center P.

A tip section 40 has a second path 41. A contour of the tip section 40 has a circular shape. A contour of the second path 41 has a substantially circular shape. A cross-sectional center P of the second path 41 is a center of the circle of the second path 41. The second path 41 has two opposing portions (i.e., a portion 42a and a portion 42b in FIG. 3) which are inwardly recessed.

As described above, the second path in accordance with the present embodiment can employ various cross-sectional shapes. In any of the cross-sectional shapes, the second path is broadened at the position apart from the cross-sectional center. With the configuration, the spray nozzle 1 in accordance with the present embodiment brings about the following effect.

As described above, in the conventional spray nozzle, the film thickness of the film tends to be unstable. In a case where the film thickness of the film is unstable, there arose a problem that film characteristics (such as electrical characteristics, adhesiveness, or hardness) also become unstable.

In contrast, in the spray nozzle 1 in accordance with the present embodiment, the second path 21 is broadened at a position apart from the cross-sectional center. With the configuration, fluid energy inside the spray nozzle 1 is lower in the central portion and higher in the edge portion, as compared with the case of using the conventional spray nozzle. Furthermore, the cross section of the second path 21 is broadened at the edge side, and therefore a film formation range of the spray nozzle 1 is also broadened. Consequently, with the spray nozzle 1, a film thickness of a film at an edge portion is increased as compared with the conventional spray nozzle, and it is possible to reduce the difference in film thickness in the entire film. Therefore, by using the spray nozzle 1, it is possible to further stabilize film properties (such as electrical characteristics, adhesiveness, or hardness).

### EXAMPLES

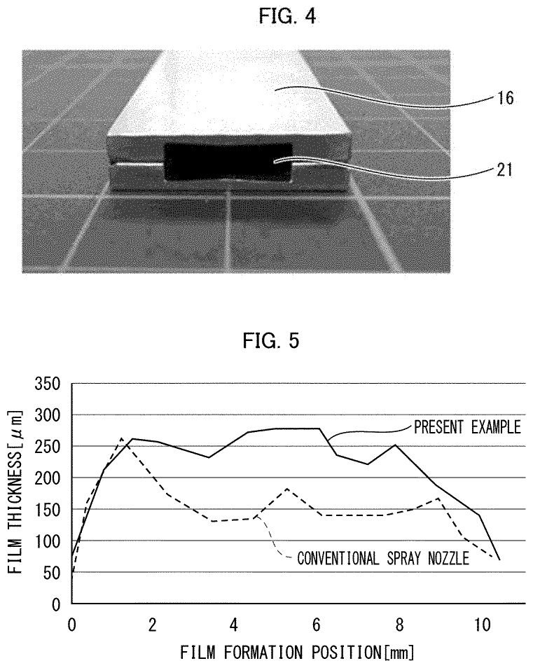

Next, an effect of the spray nozzle 1 will be described with reference to FIGS. 4 and 5.

FIG. 4 is a photograph showing an example of the tip section 16 of the spray nozzle 1 in accordance with the present Example. The second path 21 of the tip section 16 illustrated in FIG. 4 has H of 3.3 mm, W of 10 mm, and θ of 6 degrees. In the present Example, the tip section 16 is integrally formed with the cross-sectional area reduction section 10, the throat section 12, and the cross-sectional area expansion section 14. The cross-sectional shape of the first path 20 and the cross-sectional shape of the second path 21 are similar figures. The throat section 12 has a substantially rectangular cross-sectional shape with θ of 6 degrees and W of 4 mm.

FIG. 5 is a graph comparing a film thickness of a film obtained by the spray nozzle 1 illustrated in FIG. 4 with that by a conventional spray nozzle. The conventional spray nozzle has a Laval nozzle structure, and a cross section of a tip section of the conventional spray nozzle has a rectangular shape (with H of 3.3 mm, W of 10 mm, and θ of 0 degree).

The horizontal axis in FIG. 5 indicates film formation positions corresponding to a width of 10 mm of the second path 21. The vertical axis in FIG. 5 indicates a film thickness of a film which is measured with a dial gauge. The graph of FIG. 5 has been obtained under the following conditions.
Film material: Tin (Sn)
Film formation time: 3 seconds
Film formation position (measurement position of film formation): 0 mm, 2 mm, 4 mm, 6 mm, 8 mm, 10 mm
Measurement result: Average of three measurement results
Other conditions: Conditions described in (Cold spray device 100) above

From the results shown in FIG. 5, the following (1) and (2) are found.

(1) Case where the film formation positions is at the edge portion (i.e., the film formation positions are 0 mm to 1 mm, and 9 mm to 10 mm)

The results of film thicknesses obtained with use of the spray nozzle 1 and the conventional spray nozzle were similar to each other.

(2) Case where the film formation position is at the center (i.e., the film formation position is 1 mm to 9 mm)

The spray nozzle 1 significantly increased the film thickness over the conventional spray nozzle. Depending on the film thickness position, the film thickness was increased by 50% or more by using the spray nozzle 1.

Furthermore, the film thickness was stable, i.e., approximately 250 μm over the film formation position of 1 mm to 9 mm.

As the reason for (2) above, a fluid energy distribution inside the spray nozzle 1 seems to be related.

In the inside of the conventional spray nozzle, the fluid energy is highest at the center of the cross section of the spray nozzle, and becomes lower as the fluid approaches the wall surface. Consequently, a film on an object (e.g., a substrate) is thicker at the center, and becomes thinner toward edge portions. Alternatively, if the energy is excessively high at the center of the cross section of the spray nozzle, the center of the film may collapse. Thus, in the conventional spray nozzle, the film thickness of the film tends to be unstable.

According to the conventional spray nozzle illustrated FIG. 5, the film thickness is approximately 250 μm at a film formation position of approximately 1 mm, and is approximately 150 μm at a film formation position of 4 mm to 9 mm. Thus, a difference between these two film thicknesses is as much as 100 μm.

In contrast, in the present Example, the second path 21 is broadened at the position apart from the cross-sectional center P. With the configuration, the fluid energy inside the spray nozzle 1 is lower in the central portion and higher in the edge portion, as compared with the conventional spray nozzle. Thus, the energy intensity is equalized. This reduces the difference in film thickness in the film. According to the present Example illustrated in FIG. 5, the film thickness is stable at approximately 250 μm, particularly at the film formation position of 1 mm to 8 mm. In a case where the film thickness is stable, film characteristics (such as electrical characteristics, adhesiveness, or hardness) are also stable.

Aspects of the present invention can also be expressed as follows:

The spray nozzle in accordance with an aspect 1 of the present invention is a spray nozzle for use in a thermal spray device, the spray nozzle being configure to include: a nozzle main body that has a first path through which a film material and a carrier gas pass; and a nozzle tip section that is provided at a tip section of the nozzle main body and has a second path which communicates with the first path, the second path being broadened at a position apart from a cross-sectional center of the second path.

According to the configuration, it is possible to reduce a difference in film thickness in a film.

In the spray nozzle in accordance with an aspect 2 of the present invention, it is possible to employ, in the aspect 1, a configuration in which: a cross section of the first path and a cross section of the second path are similar figures; and the first path has an inner surface which is flush with an inner surface of the second path.

According to the configuration, a fluid energy distribution similar to that in the second path is formed also in the first path. This allows a larger amount of the film material to pass through the edge portion of the first path, as compared with the conventional spray nozzle. The film material which has passed through the edge portion of the first path directly passes through the edge portion of the second path. As a result, it is possible to form a film more stably, and it is possible to further reduce the difference in film thickness in the film.

In the spray nozzle in accordance with an aspect 3 of the present invention, it is possible to employ, in the aspect 1 or 2 of the present invention, a configuration in which the second path has a substantially rectangular shape.

In general, as compared with a spray nozzle having a circular cross section, a spray nozzle having a rectangular cross section makes it possible to easily reduce a film thickness at a center of a film and broaden a width of the film. Therefore, with the above configuration, the spray nozzle in accordance with the aspect 3 of the present invention can further increase film formation efficiency.

In the spray nozzle in accordance with an aspect 4 of the present invention, it is possible to employ, in any of the aspects 1 through 3 of the present invention, a configuration in which the nozzle tip section is integrated with the nozzle main body.

According to the configuration, the spray nozzle can be easily produced.

In the spray nozzle in accordance with an aspect 5 of the present invention, it is possible to employ, in any of the aspects 1 through 4 of the present invention, a configuration in which: the nozzle tip section is detachable from the nozzle main body.

According to the configuration, the nozzle tip section can be attached to a spray nozzle which has already been produced, and a difference in film thickness in a film can be reduced also in such a case.

In the spray nozzle in accordance with an aspect 6 of the present invention, it is possible, in any of the aspects 1 through 5 of the present invention, that the thermal spray device is a cold spray device.

According to the configuration, it is possible to reduce a difference in film thickness in a film while enjoying various advantages of cold spraying.

The nozzle tip section in accordance with an aspect 7 of the present invention is a nozzle tip section which is provided in a spray nozzle of a thermal spray device, and is configured so that: the nozzle tip section is provided at a tip section of a nozzle main body that has a first path through which a film material and a carrier gas pass; and the nozzle tip section has a second path which communicates with the first path, the second path being broadened at a position apart from a cross-sectional center of the second path.

According to the configuration, an effect similar to that of the above spray nozzle is brought about.

The thermal spray device in accordance with an aspect 8 of the present invention can include the spray nozzle described in any one of the aspects 1 through 6 of the present invention.

According to the configuration, the thermal spray device in accordance with the aspect 8 of the present invention can reduce a difference in film thickness in a film.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Spray nozzle

10: Cross-sectional area reduction section

12: Throat section

14: Cross-sectional area expansion section

15: Nozzle main body

16, 30, 32, 34, 36, 38, 40: Tip section (nozzle tip section)

20: First path

21, 31, 33, 35, 37, 39, 41: Second path

42a, 42b: Portion

100: Cold spray device

110: Tank

120: Heater

140: Feeder

150: Base material holder

170: Base material

1. A spray nozzle for use in a thermal spray device, said spray nozzle comprising:
a nozzle main body that has a first path through which a film material and a carrier gas pass; and
a nozzle tip section that is provided at a tip section of the nozzle main body and has a second path which communicates with the first path, the second path being broadened at a position apart from a cross-sectional center of the second path.

2. The spray nozzle as set forth in claim 1, wherein:
a cross section of the first path and a cross section of the second path are similar figures; and
the first path has an inner surface which is flush with an inner surface of the second path.

3. The spray nozzle as set forth in claim 1, wherein the second path has a substantially rectangular shape.

4. The spray nozzle as set forth in claim 1, wherein the nozzle tip section is integrated with the nozzle main body.

5. The spray nozzle as set forth in claim 1, wherein the nozzle tip section is detachable from the nozzle main body.

6. The spray nozzle as set forth in claim 1, wherein the thermal spray device is a cold spray device.

7. A nozzle tip section which is provided in a spray nozzle of a thermal spray device, wherein:
said nozzle tip section is provided at a tip section of a nozzle main body that has a first path through which a film material and a carrier gas pass; and
said nozzle tip section has a second path which communicates with the first path, the second path being broadened at a position apart from a cross-sectional center of the second path.

8. A thermal spray device, comprising a spray nozzle recited in claim 1.
